(19) United States
(12) Patent Application Publication
(10) Pub. No.: US 2025/0196867 A1
(43) Pub. Date: Jun. 19, 2025

(54) AUTONOMOUS DRIVING VEHICLE AND CONTROL METHOD THEREOF

(71) Applicants: Hyundai Motor Company, Seoul (KR); Kia Corporation, Seoul (KR)

(72) Inventor: Seung Ju Ham, Hwaseong-si (KR)

(21) Appl. No.: 18/938,704

(22) Filed: Nov. 6, 2024

(30) Foreign Application Priority Data
Dec. 15, 2023 (KR) 10-2023-0183352

(51) Int. Cl. B60W 50/00; B60W 60/00

(52) U.S. Cl. CPC B60W 50/0097; B60W 60/001; B60W 2050/0028; B60W 2510/1005; B60W 2520/10; B60W 2520/105; B60W 2552/15; B60W 2554/4041

(57) ABSTRACT

A method of controlling an autonomous vehicle including a processor, can include, under control of the processor, obtaining, from a sensor mounted inside the autonomous vehicle, driving state information of a front vehicle traveling before the autonomous vehicle, calculating a required torque based on the driving state information of the front vehicle and driving state information of the autonomous vehicle that is currently traveling, generating a virtual accelerator pedal sensor (APS) map based on the calculated required torque and the driving state information of the autonomous vehicle, predicting revolutions per minute (RPM) and a gear stage based on the generated virtual APS map, determining a final gear stage by comparing and analyzing the predicted gear stage and a preset gear stage, and in response to the determined final gear stage being out of a preset reference gear range, redetermining the final gear stage based on a shift pattern map.

### CROSS-REFERENCE TO RELATED APPLICATIONS

This application claims the benefit of Korean Patent Application No. 10-2023-0183352, filed on Dec. 15, 2023, which is hereby incorporated by reference as if fully set forth herein.

### TECHNICAL FIELD

The present disclosure relates to an autonomous vehicle and a control method thereof.

### BACKGROUND

Smart cruise control (SCC) is a driving comfort feature that assists a vehicle in traveling at a speed set by a driver while keeping a distance from a front vehicle traveling ahead of the vehicle.

SCC may transmit the set speed, a current speed, and an acceleration required based on the front vehicle to an electronic stability control (ESC) system from an advanced driver assistance system-driver (ADAS_DRV) system or a front camera. The ESC may transmit a corresponding required torque to an engine management system (EMS) in the case of an internal combustion engine and to a hybrid control unit (HCU) in the case of a hybrid electric vehicle (HEV).

The required torque and the current speed may be matched in a virtual accelerator pedal sensor (APS) map, and an APS value may be determined for SCC driving.

In addition, a transmission control unit (TCU) is a controller that controls an automatic transmission to enable optimized shifting based on various information according to a driving situation of a vehicle.

The TCU may set a target gear stage by matching a virtual APS value determined during SCC driving and a current revolutions per minute (RPM) value to an SCC driving shift pattern map.

A vehicle may use a separate driving shift pattern map for SCC driving that is different from that for normal driving.

In the past, once determined, the driving shift pattern map used for SCC driving may not be changed during development after mass production.

That is, in the case of SCC driving, the virtual APS may automatically change according to a current speed and target speed. It may also be affected by non-vehicle conditions such as road gradient, making it difficult to test on all conditions and leading to field claims if there are problems with a driving shift pattern map that is not discovered during development or problems with the driving shift pattern map in areas that are difficult to verify.

### SUMMARY

An embodiment of the present disclosure can provide an autonomous vehicle and a control method thereof that may control a shift pattern map to be automatically tuned during SCC-based driving through machine learning.

The advantages to be achieved by an embodiment of the present disclosure are not necessarily limited to those described above, and other advantages not described above may also be understood by those skilled in the art from the following description.

An embodiment of the present disclosure can solve the preceding technical problems. According to an embodiment of the present disclosure, in a method of controlling an autonomous vehicle including a processor, the method can include obtaining, by control of the processor, driving state information of a front vehicle traveling before the vehicle by a sensor, determining, by control of the processor, a required torque based on the driving state information of the front vehicle and driving state information of the vehicle, generating, by control of the processor, a virtual accelerator pedal sensor (APS) map based on the required torque and the driving state information of the vehicle, determining, by control of the processor, revolutions per minute (RPM) and a gear stage based on the virtual APS map, determining, by control of the processor, a final gear stage based on the predicted gear stage and a preset gear stage, and in response to the determined final gear stage being out of a preset reference gear range, redetermining, by control of the processor, the final gear stage based on a shift pattern map.

The driving state information of the vehicle may include a vehicle speed, a virtual APS, a vehicle longitudinal acceleration, a road gradient, a required acceleration, and the RPM, and the method may include predicting, by control of the processor, a correlation between the vehicle speed, the virtual APS, the vehicle longitudinal acceleration, the road gradient, the required acceleration, and the RPM.

The method may also include extracting, by control of the processor, feature values from the vehicle speed and the virtual APS, and generating a neural network model configured to predict the RPM based on the feature values.

The method may also include training the neural network model with learning data until a determination coefficient, which can be a result value of a correlation coefficient, reaches a preset reference value.

The method may also include subdividing, by control of the processor, the virtual APS map, and predicting the RPM per index based on the subdivided virtual APS map.

The method may also include determining, by control of the processor, whether the final gear stage per index is suitable or not based on the virtual APS map, and determining, by control of the processor, whether to change the shift pattern map based on a result of the determining.

The method may also include in response to the determined final gear stage being within the preset reference gear range, determining, by control of the processor, the final gear stage as a current gear stage.

The method may also include, in response to the determined final gear stage being out of the preset reference gear range and so there being a problem in the index, lowering, by control of the processor, the RPM set in the shift pattern map.

According to an embodiment of the present disclosure, an autonomous vehicle includes a processor, wherein the processor may be configured to obtain, by a sensor, driving state information of a front vehicle traveling before the vehicle, determine a required torque based on the driving state information of the front vehicle and driving state information of the vehicle, generate a virtual accelerator pedal sensor (APS) map based on the required torque and the driving state information of the vehicle, determine revolutions per minute (RPM) and a gear stage based on the virtual APS map, determine a final gear stage based on the predicted gear stage and a preset gear stage, and in response to the determined final gear stage being out of a preset reference gear range, redetermine the final gear stage based on a shift pattern map.

The driving state information of the vehicle may include a vehicle speed, a virtual APS, a vehicle longitudinal acceleration, a road gradient, a required acceleration, and the RPM, and the processor may be configured to predict a correlation between the vehicle speed, the virtual APS, the vehicle longitudinal acceleration, the road gradient, the required acceleration, and the RPM.

The processor may be configured to extract feature values from the vehicle speed and the virtual APS, and generate a neural network model configured to predict the RPM based on the feature values.

The processor may be configured to train the neural network model with learning data until a determination coefficient, which can be a result value of a correlation coefficient, reaches a preset reference value.

The processor may be configured to subdivide the virtual APS map, and predict the RPM per index based on the subdivided virtual APS map.

The processor may be configured to determine whether the final gear stage per index is suitable or not based on the virtual APS map, and determine whether to change the shift pattern map based on a result of the determining.

The processor may be configured to, in response to the determined final gear stage being within the preset reference gear range, determine the final gear stage as a current gear stage.

The processor may be configured to, in response to the determined final gear stage being out of the preset reference gear range and so there being a problem in the index, lower the RPM set in the shift pattern map.

An autonomous vehicle and a control method configured as described above according to embodiments of the present disclosure may have the following advantages.

An embodiment of the present disclosure can automatically identify hidden problems in areas that are difficult to verify during vehicle development.

An embodiment of the present disclosure can automatically tune a shift pattern map reflecting therein the characteristics of each of mass-produced vehicles.

An embodiment of the present disclosure can improve shifting performance on the driver's side without adding much software and hardware, compared to typical systems.

An embodiment of the present disclosure can ensure a quieter driving experience, increasing the driver's reliability in the system.

The advantages that can be achieved by an embodiment of the present disclosure are not necessarily limited to those described above, and other advantages not described above may also be understood by a person having ordinary skill in the art to which the present disclosure pertains from the following description.

### BRIEF DESCRIPTION OF THE DRAWINGS

FIG. 1 is a block diagram illustrating an autonomous vehicle according to an embodiment of the present disclosure.

FIG. 2 is a flowchart illustrating a method of controlling an autonomous vehicle according to an embodiment of the present disclosure.

FIG. 3 is a diagram illustrating a result for a correlation coefficient between sets of sensor data according to an embodiment of the present disclosure.

FIGS. 4A and 4B are diagrams illustrating a correlation among revolutions per minute (RPM), vehicle speed, and virtual accelerator pedal sensor (APS), according to an embodiment of the present disclosure.

FIGS. 5A and 5B are diagrams illustrating an example of predicting RPM based on speed according to an embodiment of the present disclosure.

FIG. 6 is a diagram illustrating an example of predicting RPM for each index in a virtual APS map according to an embodiment of the present disclosure.

FIGS. 7A and 7B are diagrams illustrating a subdivided example of the virtual APS map illustrated in FIG. 6.

FIGS. 8A and 8B are diagrams illustrating a shift pattern map according to an embodiment of the present disclosure.

FIGS. 9A and 9B are diagrams illustrating a result of predicting a gear stage according to an embodiment of the present disclosure.

FIGS. 10A and 10B are diagrams illustrating an example of determining a final gear stage for each index in a subdivided virtual APS map according to an embodiment of the present disclosure.

FIG. 11 is a diagram illustrating an example of determining the suitability of a final gear stage for each index in a subdivided virtual APS map according to an embodiment of the present disclosure.

FIGS. 12A and 12B are diagrams illustrating an example of determining whether there is a down pattern and a reversal phenomenon based on a shift pattern tuning result according to an embodiment of the present disclosure.

### DETAILED DESCRIPTION OF ILLUSTRATIVE EMBODIMENTS

Hereinafter, example embodiments of the present disclosure will be described in detail with reference to the accompanying drawings, and same or similar elements can be given same reference numerals regardless of reference symbols, and a repeated description thereof can be omitted. Further, when describing the example embodiments, when it is determined that a detailed description of related publicly known technology can obscure the gist of the embodiments described herein, the detailed description thereof can be omitted.

As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof. In addition, when describing the embodiments with reference to the accompanying drawings, like reference numerals refer to like components and a repeated description related thereto will be omitted.

The terms “unit” and “control unit” included in names such as a vehicle control unit (VCU) may be terms widely used in the naming in the industry of a control device or controller configured to control vehicle-specific functions but may not be a term that represents a generic function unit. For example, each controller or control unit may include a communication device that communicates with other controllers or sensors to control a corresponding function, a memory that stores an operating system (OS) or logic commands and input/output information, and at least one vehicle controller that performs determination, calculation, selection, and the like to control the function. The vehicle controller may also be referred to herein as a drive controller.

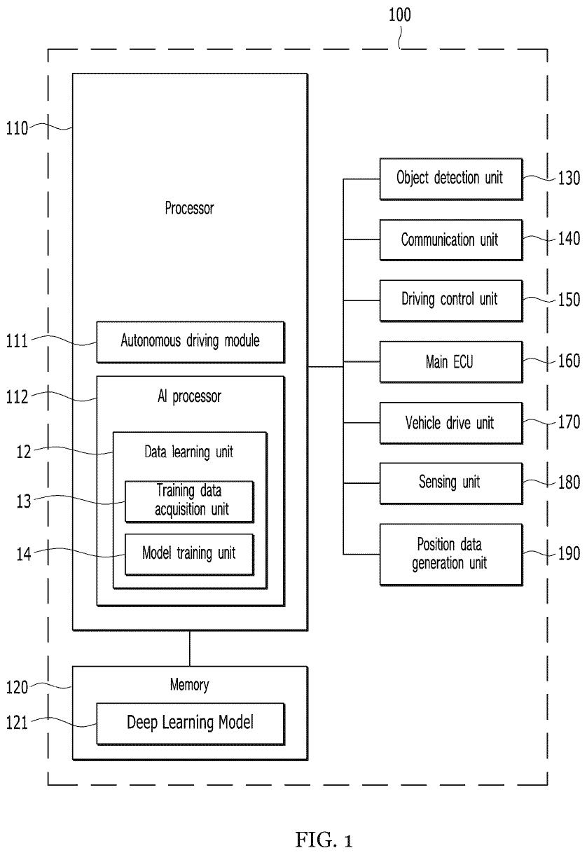

FIG. 1 is a block diagram illustrating an autonomous vehicle according to an embodiment of the present disclosure.

Referring to FIG. 1, according to an embodiment, an autonomous vehicle 100 may include a processor 110 and a memory 120, either or both of which may be in plural or may include plural components thereof. The processor 110 may include an autonomous driving module 111 and an artificial intelligence (AI) processor 112, either or both of which may be in plural or may include plural components thereof.

The autonomous vehicle 100 may include an interface portion (not shown) that is wired or wirelessly connected to at least one electronic device provided in the autonomous vehicle 100 to exchange data necessary for autonomous driving control.

The interface portion may be configured as at least one of a communication module, a terminal, a pin, a cable, a port, a circuit, an element, and a device.

For example, the at least one electronic device may be electrically connected via the interface portion (not shown). The at least one electronic device may include, as non-limiting examples, an object detection unit 130, a communication unit 140, a driving control unit 150, a main electronic control unit (ECU) 160, a vehicle drive unit 170, a sensing unit 180, and a position data generation unit 190, any combination of or all of which may be in plural or may include plural components thereof. These will be described in more detail below.

The processor 110 may be electrically connected to the memory 120, the interface portion (not shown), and a battery portion (not shown) to exchange signals therewith. The processor 110 may be implemented using at least one of an application-specific integrated circuit (ASIC), a digital signal processor (DSP), a digital signal processing device (DSPD), a programmable logic device (PLD), a field-Programmable gate array (FPGA), a controller, a microcontroller, a microprocessor, and other electrical units for performing functions, for example.

The processor 110 may be driven by power provided by the battery portion (not shown). The processor 110 may receive data, process data, generate signals, and provide signals while powered by the battery portion (not shown).

The processor 110 may receive information from other electronic devices in the autonomous vehicle 100 via the interface portion. The processor 110 may provide control signals to the other electronic devices in the autonomous vehicle 100 via the interface portion.

For example, the processor 110 may obtain driving state information of a front vehicle that is traveling before the autonomous vehicle 100 from a sensor mounted inside the autonomous vehicle 100, calculate a required torque based on the driving state information of the front vehicle and driving state information of the autonomous vehicle 100 that is currently traveling, and generate a virtual accelerator pedal sensor (APS) map based on the calculated required torque and the driving state information of the autonomous vehicle 100.

However, examples are not limited thereto, and as needed, the AI processor 112, which will be described below, may receive the calculated required torque and the driving state information of the autonomous vehicle 100 from the processor 110 to generate the virtual APS map.

The processor 110 may predict revolutions per minute (RPM) and a gear stage based on the generated virtual APS map, determine a final gear stage by comparing and analyzing the predicted gear stage and a preset gear stage, and, in response to the determined final gear stage being out of a preset reference gear range, control the final gear stage based on a shift pattern map. Hereinafter, the autonomous vehicle 100 can also be referred to as a vehicle or an ego vehicle, for ease of explanation.

The memory 120 may be electrically connected to the processor 110. The memory 120 may store various programs and data required for operations of the autonomous vehicle 100. That is, the memory 120 may store basic data about the autonomous vehicle 100, control data for controlling the operations of the autonomous vehicle 100, and input and output data. The memory 120 may also store data processed by the processor 110.

The memory 120 may be accessed by the processor 110 or the AI processor 112, and may allow the AI processor 112 to read/write/record/modify/delete/update/restore data. Additionally, the memory 120 may store a neural network model (e.g., a deep learning model) generated by a learning algorithm for data classification/recognition according to an embodiment of the present disclosure.

As a storage medium, the memory 120 may include, in terms of hardware, at least one of a read-only memory (ROM), a random-access memory (RAM), an erasable programmable ROM (EPROM), a flash drive, a hard drive, a non-volatile memory, a volatile memory, a flash memory, a hard disk drive (HDD), or a solid-state drive (SSD), for example. The memory 120 may store various data for overall operations of the autonomous vehicle 100 including, for example, programs for processing or controlling performed by the processor 110. The memory 120 may be implemented in an integral form with the processor 110. In some embodiments, the memory 120 may be classified as a subcomponent of the processor 110.

The autonomous vehicle 100 may include at least one printed circuit board (PCB). The memory 120, the interface portion (not shown), the battery portion (not shown), and the processor 110 may be electrically connected to the PCB.

Hereinafter, other electronic devices in the vehicle 100 connected to the interface portion, the autonomous driving module 111, and the AI processor 112 will be described in more detail.

The autonomous driving module 111 may generate a route for autonomous driving based on the obtained data and generate a driving plan for driving along the generated route, under control of the processor 110.

The autonomous driving module 111 may implement at least one advanced driver-assistance system (ADAS) function. The ADAS function may implement any of the following: an adaptive cruise control (ACC) system, an autonomous emergency braking (AEB) system, a forward collision warning (FCW) system, a lane keeping assist (LKA) system, a lane change assist (LCA) system, a target following assist (TFA) system, a blind spot detection (BSD) system, an adaptive high beam assist (HBA) system, an auto parking system (APS), a pedestrian (PD) collision warning system, a traffic sign recognition (TSR) system, a traffic sign assist (TSA) system, a night vision (NV) system, a driver status monitoring (DSM) system, a traffic jam assist (TJA) system, or any combination thereof, for example. However, examples are not limited thereto.

The AI processor 112 may apply, to the neural network model, traffic-related information received from at least one sensor provided in the vehicle 100 and external devices and information received from other vehicles communicating with the vehicle 100, and may transmit control signals for executing the at least one ADAS function described above to the autonomous driving module 111.

For example, the AI processor 112 may generate the virtual APS map using at least one neural network model or the like.

The vehicle 100 may transmit at least one data for executing the ADAS function to the AI processor 112 via the interface portion, and the AI processor 112 may apply the transmitted data to the neural network model to transmit the control signals for executing the ADAS function to the vehicle 100. However, examples are not limited thereto.

The AI processor 112 may be configured to be included as part of the vehicle 100 to perform at least part of AI processing together with the vehicle 100.

The AI processing described above may include all operations associated with driving of the autonomous vehicle 100. For example, the autonomous vehicle 100 may perform the AI processing on sensing data (or sensor data) to perform processing/determination, control signal generation, or the like. However, examples are not limited thereto.

For example, the autonomous vehicle 100 may also perform the AI processing on data obtained through interactions with other electronic devices provided in the vehicle 100.

The AI processor 112, which can be a computing device configured to train or learn a neural network, may be implemented as various electronic devices.

The AI processor 112 may train the neural network using a program stored in the memory 120. For example, the AI processor 112 may train a neural network for recognizing vehicle-related data. The neural network for recognizing vehicle-related data may be designed to computationally simulate the structure of a human brain and may include a plurality of network nodes with weights that simulate neurons in a human neural network. The plurality of network nodes may each exchange data based on their connectivity relationships to simulate synaptic activities of neurons, where the neurons exchange signals across synapses. In this context, the neural network may include a deep learning model evolved from a neural network model. In the deep learning model, a plurality of network nodes may be in different layers and exchange data based on convolutional connections.

The neural network model may include, as non-limiting examples, a deep neural network (DNN), a convolutional neural network (CNN), a recurrent neural network (RNN), a restricted Boltzmann machine (RBM), a deep belief network (DBN), and a deep Q-network, and may be applied to various technical fields such as computer vision, speech recognition, natural language processing, and speech/signal processing, for example.

The AI processor 112 may include a data learning unit 12 configured to train a neural network for data classification/recognition.

The data learning unit 12 may learn what training data to use for data classification/recognition, and criteria for how to use the training data to classify and recognize data.

The data learning unit 12 may train the deep learning model (e.g., a deep learning model 121) by obtaining training data to be used for training (or learning) and applying the obtained training data to the deep learning model 121. For example, the data learning unit 12 may apply the training data provided by the processor 110, such as, the required torque and the driving state information of the autonomous vehicle 100, to the deep learning model 121, and may generate the virtual APS map based on the training data. The virtual APS map may be a map that may determine an APS (value) depending on a required torque and a current speed. However, examples are not limited thereto, and the data learning unit 12 may generate a shift pattern map. The shift pattern map may be a map that may determine a gear stage in response to a determined APS (or APS value) and a current RPM (or RPM value) of a vehicle.

The data learning unit 12 may be fabricated in the form of at least one hardware chip and mounted on the autonomous vehicle 100. For example, the data learning unit 12 may be fabricated as an AI-dedicated hardware chip or as part of a general-purpose processor (e.g., a central processing unit (CPU)) or a graphics-only processor (e.g., a graphics processing unit (GPU)) and mounted on the autonomous vehicle 100.

The data learning unit 12 may also be implemented as a software module. When implemented as at least one software module (or a program module including instructions), the software module may be stored in a non-transitory computer-readable medium (storage medium) that is readable by a computer. The at least one software module may be provided by an operating system (OS) or may be provided by an application.

The data learning unit 12 may include a training data acquisition unit 13 and a model training unit 14.

The training data acquisition unit 13 may obtain the training data required for the neural network model to classify and recognize data. For example, the training data acquisition unit 13 may obtain, as the training data, vehicle data and/or sample data to be input to the neural network model. For example, the vehicle data may include the required torque or the driving state information of the autonomous vehicle 100.

The model training unit 14 may train the neural network model such that it has determination criteria for how to classify data, using the obtained training data. The model training unit 14 may train the neural network model through supervised learning that uses at least a portion of the training data as the determination criteria.

Alternatively, the model training unit 14 may train the neural network model through unsupervised learning that discovers the determination criteria by learning on its own using the training data without supervision.

Alternatively, the model training unit 14 may train the neural network model through reinforcement learning, using feedback on whether a result of determining a situation from training is correct. The neural network model may include, for example, a correlation analysis, a regression analysis, a linear regression model, a multiple linear regression model, a determination coefficient, or the like.

For example, the correlation analysis, also referred to as a “correlative relationship” or “correlation,” may analyze what linear or non-linear relationship exists between two variables, in statistics. The two variables may be independent of each other or correlated with each other, and the strength of the relationship between the two variables may be referred to as a correlation or a correlation coefficient.

The regression analysis may obtain a model between two observed continuous variables and measuring a fitness. Analyzing a relationship between one dependent variable and one independent variable may be referred to as a simple regression analysis, and identifying a relationship between one dependent variable and multiple independent variables may be referred to as a multiple regression analysis.

The linear regression model may refer to a supervised learning algorithm that is used primarily for numerical prediction problems, i.e., a model that uses an independent variable (input variable, X) to predict a numerical dependent variable (output variable, Y). The linear regression model may model a relationship between the input variable X and the output variable Y, using a linear expression to describe the relationship between the independent variable and the dependent variable.

The multiple linear regression model may refer to a model that uses multiple independent variables (input variables, X) to predict a dependent variable (output variable, Y). Because the multiple linear regression model uses multiple characteristics to predict the dependent variable, it may be expected to perform better than ordinary linear regression.

The determination coefficient may refer to a ratio that is described as an independent variable, of a variance of dependent variables in the linear regression analysis using the least squares method. That is, the determination coefficient may be a numerical representation of how well a statistical model can explain a target.

For example, the variance of dependent variables in the linear regression analysis may be estimated as a sum of squared differences, i.e., a sum of squared total (SST), from the mean.

$$SST = {\sum }_{i = 1}^{n} {( yi - {y}^{-} )}^{2} \qquad [ Equation 1 ]$$

In Equation 1 above, if a value estimated by the model is yⁱ, an SSR of the residuals can be as follows in Equation 2.

$$SSR = {\sum }_{i = 1}^{n} {( yi - {y}^{i} )}^{2} \qquad [ Equation 2 ]$$

Using Equation 2, a determination coefficient R² can be expressed as in Equation 3.

$${R}^{2} = 1 - ( SST / SSR ) \qquad [ Equation 3 ]$$

That is, the determination coefficient may be used as a measure of the explanatory power of the model for a dependent variable. If the purpose of the linear model is to predict the dependent variable, a high value may be desirable. This can be because R² itself can be an indicator of how well the linear model represents the behavior of the dependent variable.

However, examples are not limited thereto, and the model training unit 14 may train the neural network model using a learning algorithm including error backpropagation or gradient decent, for example.

Once the neural network model is trained, the model training unit 14 may store the trained neural network model in the memory 120.

The data learning unit 12 may further include a training data preprocessing unit (not shown) and a training data selection unit (not shown) to improve analysis results of the recognition model or to save resources or time required to generate the recognition model.

The training data preprocessing unit may preprocess obtained data such that the obtained data is to be used for contextual determination. For example, the training data preprocessing unit may process the obtained data into a preset format such that the model training unit 14 may use the obtained training data for training for image recognition.

The training data selection unit may select data required for training, from the training data obtained by the training data acquisition unit 13 or the training data preprocessed by the training data preprocessing unit. The selected training data may be provided to the model training unit 14. For example, the training data selection unit may detect a specific area in object data about objects obtained through the object detection unit 130 of the autonomous vehicle 100, and select object data only about objects included in the specific area as the training data.

The data learning unit 12 may further include a model evaluation unit (not shown) to improve the analysis results of the neural network model.

The model evaluation unit may input evaluation data to the neural network model and, when analysis results output from the evaluation data do not satisfy predetermined criteria, may allow the model training unit 14 to be retrained. The evaluation data may be data predefined for evaluating the recognition model.

For example, when, of the analysis results of the trained recognition model in response to the evaluation data, the number or ratio of evaluation data with incorrect analysis results exceeds a preset threshold, the model evaluation unit may evaluate that the analysis results do not satisfy the predetermined criteria.

The object detection unit 130 may generate information about objects detected from the outside of the vehicle 100. For example, the AI processor 112 may apply the neural network model to such object data obtained via the object detection unit 130 to generate at least one of the following: presence of an object, position information of the object, distance information between the vehicle 100 and the object, relative speed information between the vehicle 100 and the object, or any combination thereof.

The object detection unit 130 may include at least one sensor configured to detect objects from the outside of the vehicle 100. For example, the sensor(s) may include at least one of a camera, a radar, a lidar, an ultrasonic sensor, an infrared sensor, or any combination thereof.

The object detection unit 130 may provide at least one electronic device included in the vehicle 100 with object data generated based on a sensor signal generated by the sensor.

The vehicle 100 may generate AI processing data by applying the data obtained via the at least one sensor to the neural network model, under control of the processor 110. The vehicle 100 may recognize information about a detected object based on the generated AI processing data. The vehicle 100 may perform an autonomous driving control operation using the recognized information, under the control of the autonomous driving module 111.

The communication unit 140 may exchange signals with devices located outside the vehicle 100. The communication unit 140 may exchange signals with at least one of an infrastructure (e.g., a server, a broadcasting station, etc.), another vehicle, a terminal, or any combination thereof. The communication unit 140 may include at least one of a transmitting antenna, a receiving antenna, a radio frequency (RF) circuit or element capable of implementing various communication protocols to perform communication, or any combination thereof, for example.

However, examples are not limited thereto, and the communication unit 140 may exchange signals, by wire or wirelessly, with other electronic devices mounted inside the vehicle 100, under control of the processor 110. For example, a plurality of electronic devices included in the vehicle 100 may exchange signals via the communication unit 140 or the interface portion. The signals may include data. The communication unit 140 may use at least one communication protocol (e.g., CAN, LIN, Flex Ray, MOST, Ethernet).

The driving control unit 150 may be a device configured to receive driver inputs for driving from a driver. For example, when in a manual mode, the vehicle 100 may be operated based on signals provided by the driving control unit 150. The driving control unit 150 may include a steering input device (e.g., a steering wheel), an acceleration input device (e.g., an accelerator pedal), and a brake input device (e.g., a brake pedal).

In an autonomous driving mode, the AI processor 112 may generate input signals of the driving control unit 150 in response to signals for controlling the movement of the vehicle 100 according to the driving plan generated through the autonomous driving module 111. However, examples are not limited thereto.

The vehicle 100 may receive data necessary for controlling the driving control unit 150 via the communication unit 140 or the interface portion and apply it to the neural network model to generate the AI processing data, under control of the processor 110. The vehicle 100 may use the input signals of the driving control unit 150 based on the generated AI processing data to control the movement of the vehicle 100, under control of the processor 110.

The main ECU 160 may control the overall operations of at least one electronic device provided in the vehicle 100.

The vehicle drive unit 170 may electrically control various vehicle drive devices in the vehicle 100. The vehicle drive unit 170 may include, for example, a powertrain drive control unit, a chassis drive control unit, a door/window drive control unit, a safety device drive control unit, a lamp drive control unit, an air conditioning drive control unit, or any combination thereof, for example.

The powertrain drive control unit may include a power source drive control unit and a transmission drive control unit. The chassis drive control unit may include a steering drive control unit, a brake drive control unit, and a suspension drive control unit.

The safety device drive control unit may include a seatbelt drive control unit for controlling seatbelts.

The vehicle drive unit 170 may include at least one electronic control unit (e.g., an ECU).

The vehicle drive unit 170 may control a powertrain, a steering device, and a brake device based on signals received from the autonomous driving module 111. The signals received from the autonomous driving module 111 may be drive control signals generated by the AI processor 112 by applying the vehicle-related data to the neural network model.

The sensing unit 180 may sense a state of the vehicle 100. For example, the sensing unit 180 may include at least one of the following: an inertial measurement unit (IMU) sensor, a collision sensor, a wheel sensor, a speed sensor, an inclination sensor, a weight sensing sensor, a heading sensor, a position module, a vehicle forward/backward driving sensor, a battery sensor, a fuel sensor, a tire sensor, a steering sensor, a temperature sensor, a humidity sensor, an ultrasonic sensor, an illumination sensor, a pedal position sensor, or any combination thereof. The IMU sensor may include at least one of an acceleration sensor, a gyro sensor, a magnetic sensor, or any combination thereof.

The AI processor 112 may generate vehicle state data by applying the sensing data generated by the at least one sensor to the neural network model.

The AI processed vehicle state data generated by applying the neural network model may include, for example, vehicle posture data, vehicle motion data, vehicle yaw data, vehicle roll data, vehicle pitch data, vehicle collision data, vehicle direction data, vehicle angle data, vehicle speed data, vehicle acceleration data, vehicle tilt data, vehicle forward/backward driving data, vehicle weight data, battery data, fuel data, tire pressure data, vehicle internal temperature data, vehicle internal humidity data, steering wheel rotation angle data, vehicle external illumination data, data of pressure applied to an accelerator pedal, data of pressure applied to a brake pedal, or the like, or any combination thereof.

The autonomous driving module 111 may generate driving control signals based on the AI processed vehicle state data.

The vehicle 100 may transmit the sensing data obtained via the at least one sensor to the AI processor 112, apply it to the neural network model, and transmit the generated AI processing data to the autonomous driving module 111.

The position data generation unit 190 may generate position data of the vehicle 100. The position data generation unit 190 may include at least one of a GPS or a differential global positioning system (DGPS).

The AI processor 112 may apply the neural network model to the position data generated by the at least one position data generation unit 190 to generate more accurate position data of the vehicle 100.

According to an embodiment, the AI processor 112 may perform deep learning computation based on at least one of the IMU of the sensing unit 180 or the camera image of the object detection unit 130, and may correct the position data based on the generated AI processing data.

The processor 110 performing the functions described above may be a general-purpose processor (e.g., CPU), but may also be an AI-dedicated processor (e.g., GPU) for AI learning, for example.

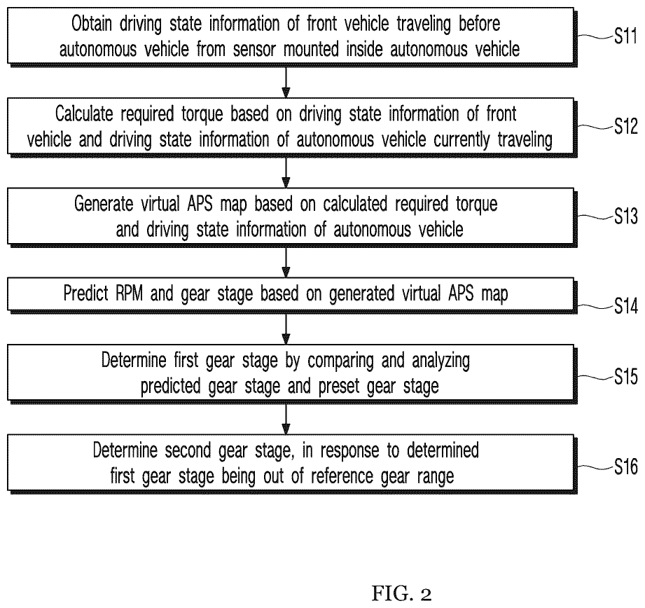

FIG. 2 is a flowchart illustrating a method of controlling an autonomous vehicle according to an embodiment of the present disclosure.

Referring to FIG. 2, according to an embodiment of the present disclosure, a method of controlling an autonomous vehicle including a processor can be as follows.

In operation S11, the autonomous vehicle may obtain driving state information of a front vehicle that is traveling before the autonomous vehicle from a sensor mounted inside the autonomous vehicle, under control of the processor.

In operation S12, the autonomous vehicle may calculate or determine (e.g., using a lookup table and/or data model) a required torque based on the driving state information of the front vehicle and driving state information of the autonomous vehicle (or an ego vehicle) that is currently traveling, under control of the processor.

In operation S13, the autonomous vehicle may generate a virtual APS map based on the calculated/determined required torque and the driving state information of the ego vehicle, under control of the processor.

In operation S14, the autonomous vehicle may predict RPM and a gear stage based on the generated virtual APS map, under control of the processor.

In operation S15, the autonomous vehicle may determine a final gear stage by comparing and analyzing the predicted gear stage to a preset reference gear range, under control of the processor.

In operation S16, in response to the determined final gear stage being out of the preset reference gear range, the autonomous vehicle may determine the final gear stage based on a shift pattern map, under control of the processor.

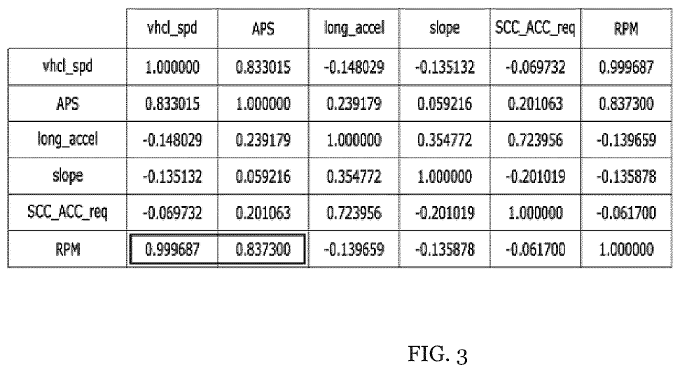

The method of controlling the autonomous driving vehicle including the processor according to an embodiment of the present disclosure described above will be described in more detail below with reference to FIGS. 3 to 12 with some example data.

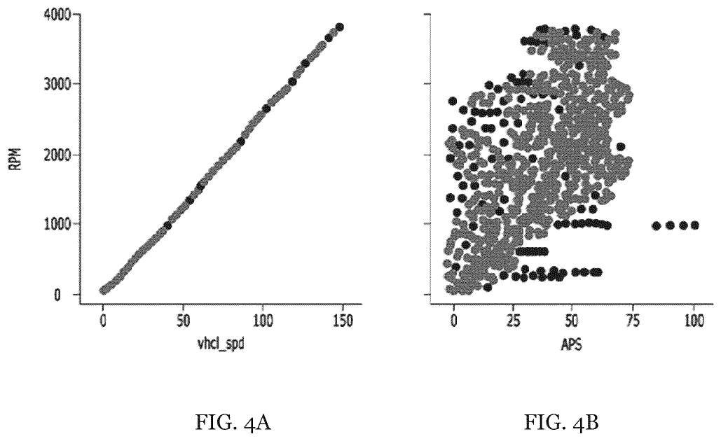

FIG. 3 is a diagram illustrating a result for a correlation coefficient between pieces of sensor data according to an embodiment of the present disclosure. FIGS. 4A and 4B are diagrams illustrating a correlation among RPM, a vehicle speed, and a virtual APS, according to an embodiment of the present disclosure.

Referring to FIGS. 3, 4A, and 4B, the autonomous vehicle 100 may predict a correlation between pieces of sensor data obtained while traveling on a road based on a result for a correlation coefficient between the sensor data, under control of the processor 110. The sensor data may include a vehicle speed (vhcl_spd), a virtual APS, a vehicle longitudinal acceleration, a road gradient, a required acceleration, RPM, and the like.

For example, the processor 110 may receive a vehicle speed (vhcl_spd), a virtual APS, a vehicle longitudinal acceleration (long_accel), a road gradient (slope), a required acceleration (SCC_ACC_req), RPM, and the like from the autonomous vehicle 100 that is currently traveling on the road, and may compare and analyze these to predict or check a correlation between them.

For example, the processor 110 may determine a result value of a correlation coefficient analyzed for each of the virtual APS, the vehicle longitudinal acceleration (long_accel), the road gradient (slope), the required acceleration (SCC_ACC_req), and the RPM, with respect to the vehicle speed (vhcl_spd). That is, for example, the processor 110 may determine the result value between the vehicle speed (vhcl_spd) and the virtual APS to be 0.833015; the result value between the vehicle speed (vhcl_spd) and the vehicle longitudinal acceleration (long_accel) to be −0.148029; the result value between the vehicle speed (vhcl_spd) and the road gradient (slope) to be −0.135132; the result value between the vehicle speed (vhcl_spd) and the required acceleration (SCC_ACC_req) to be −0.069732; and the result value between the vehicle speed (vhcl_spd) and the RPM to be 0.999687.

The processor 110 may also determine a result value of a correlation coefficient analyzed for each of the vehicle speed (vhcl_spd), the vehicle longitudinal acceleration (long_accel), the road gradient (slope), the required acceleration (SCC_ACC_req), and the RPM, with respect to the virtual APS. That is, for example, the processor 110 may determine the result value between the virtual APS and the vehicle longitudinal acceleration (long_accel) to be 0.239179; the result value between the virtual APS and the road gradient (slope) to be 0.059216; the result value between the virtual APS and the required acceleration (SCC_ACC_req) to be 0.201063; and the result value between the virtual APS and the RPM to be 0.837300.

The processor 110 may also determine a result value of a correlation coefficient analyzed for each of the vehicle speed (vhcl_spd), the virtual APS, the road gradient (slope), the required acceleration (SCC_ACC_req), and the RPM, with respect to the vehicle longitudinal acceleration (long_accel). That is, for example, the processor 110 may determine the result value between the vehicle longitudinal acceleration (long_accel) and the road gradient (slope) to be 0.354772; the result value between the vehicle longitudinal acceleration (long_accel) and the required acceleration (SCC_ACC_req) to be 0.723956; and the result value between the vehicle longitudinal acceleration (long_accel) and the RPM to be −0.139659.

The processor 110 may also determine a result value of a correlation coefficient analyzed for each of the vehicle speed (vhcl_spd), the virtual APS, the vehicle longitudinal acceleration (long_accel), the required acceleration (SCC_ACC_req), and the RPM, with respect to the road gradient (slope). That is, for example, the processor 110 may determine the result value between the road gradient (slope) and the required acceleration (SCC_ACC_req) to be −0.201019; and the result value between the road gradient (slope) and the RPM to be −0.135878.

The processor 110 may also determine a result value of a correlation coefficient analyzed for each of the vehicle speed (vhcl_spd), the virtual APS, the vehicle longitudinal acceleration (long_accel), the road gradient (slope), and the RPM, with respect to the required acceleration (SCC_ACC_req). That is, for example, the processor 110 may determine the result value between the required acceleration (SCC_ACC_req) and the RPM to be −0.061700.

As described above, as the result value of the correlation coefficient is closer to “1,” a correlation may increase. For example, it may be verified that an RPM value is highly correlated with the virtual APS in addition to the vehicle speed (vhcl_spd).

A more detailed graphical representation of RPM, vehicle speed (vhcl_spd), and virtual APS is shown in FIGS. 4A and 4B.

In FIG. 4A, the vertical direction (or Y direction) may represent RPM, and the horizontal direction (or X direction) may represent vehicle speed (vhcl_spd). It may be verified that, as the vehicle speed (vhcl_spd) increases, the RPM may increase correspondingly.

In FIG. 4B, the vertical direction (or Y direction) may represent RPM, and the horizontal direction (or X direction) may represent virtual APS. It may be verified that, as the virtual APS increases, the RPM may increase correspondingly.

As shown in FIG. 4, it may be verified that the RPM is highly linearly correlated with the virtual APS in addition to the vehicle speed (vhcl_spd).

That is, although the vehicle speed (vhcl_spd) is affected solely by the RPM, it is highly linearly correlated with the APS, as shown in FIGS. 3, 4A, and 4B. Thus, feature values may be extracted from the vehicle speed (vhcl_spd) and the virtual APS, and a neural network model that may predict the RPM based on the feature values may be generated. The neural network model has been fully described above with reference to FIG. 1, and thus a more detailed and repeated description thereof will be omitted here. Here, the neural network model may include the multiple linear regression model described above.

For example, the processor 110 may predict the RPM based on the multiple linear regression model, which is one of the neural network models. For example, the multiple linear regression model configured to predict RPM may differentiate by gear stage, under control of the processor 110. This can be because, when the engine revolves, the wheels revolve while engaging with gears, and the gears may allow the engine and the wheels to revolve differently with different numbers of revolutions.

Furthermore, the predicted RPM may be used in a shift pattern map. The shift pattern map may be divided by road gradient. Based on this, the processor may generate the multiple linear regression model.

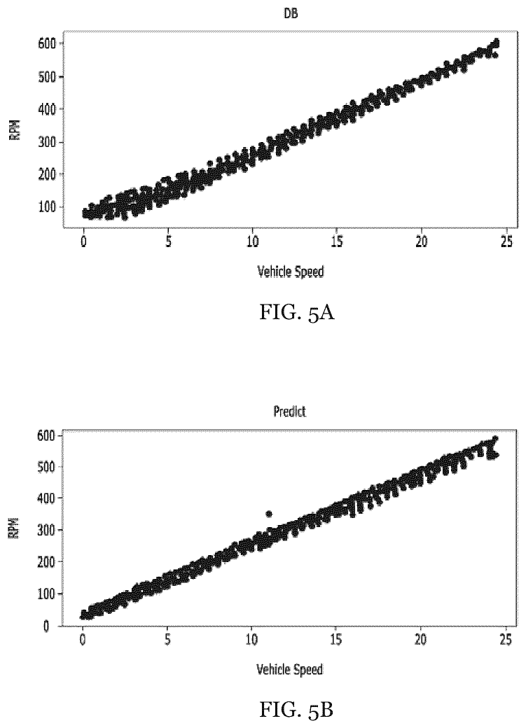

That is, the processor 110 may generate the multiple linear regression model, which can be an RPM prediction model, divided by gear stage and road gradient. The one based on the road gradient may follow the shift pattern map, which may be represented as a graph shown in FIGS. 5A and 5B.

FIGS. 5A and 5B are diagrams illustrating an example of predicting RPM based on speed according to an embodiment of the present disclosure.

Referring to FIGS. 5A and 5B, FIG. 5A shows actual RPM by speed, and FIG. 5B shows predicted RPM by speed. The prediction may be based on data obtained while the autonomous vehicle is traveling on a flat surface at a first gear.

In FIG. 5A, the vertical direction (Y direction) represents the actual RPM, and the horizontal direction (X direction) represents the speed. In FIG. 5B, the vertical direction (Y direction) represents the predicted RPM, and the horizontal direction (X direction) represents the speed.

As shown in FIG. 5B, the predicted RPM may be represented by a linear line that is substantially similar to the actual RPM.

The processor may generate a multiple linear regression model, which is a more accurate RPM prediction model, by continuously learning the data until a determination coefficient, which can be a result value of a correlation coefficient, is greater than or equal to 0.99.

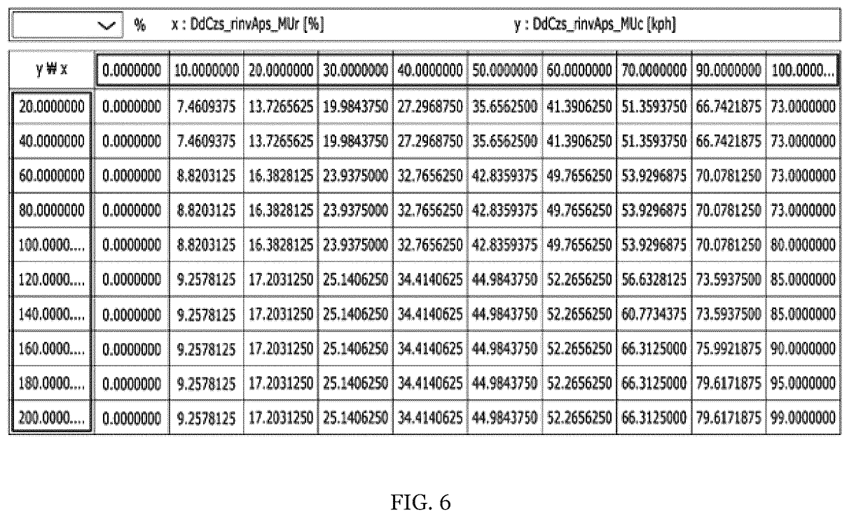

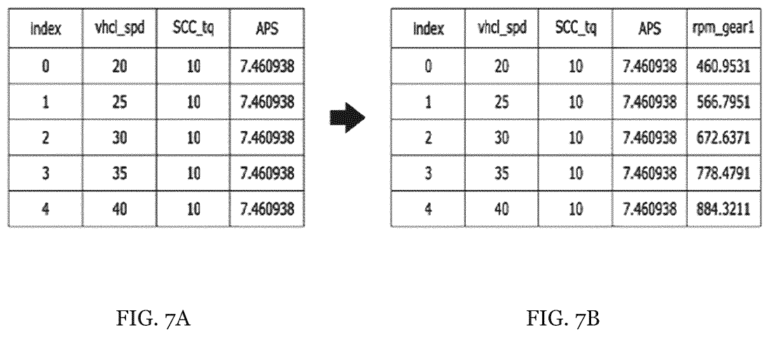

FIG. 6 is a diagram illustrating an example of predicting RPM for each index in a virtual APS map according to an embodiment of the present disclosure. FIGS. 7A and 7B are diagrams illustrating a detailed example of the virtual APS map shown in FIG. 6.

Referring to FIG. 6, the autonomous vehicle may generate a virtual APS map based on an APS determined by a required torque and a current driving speed during SCC driving, under the control of the processor.

In FIG. 6, the vertical direction (Y direction) represents the current driving speed, and the horizontal direction (X direction) represents the required torque. However, examples are not limited thereto, and elements of the virtual APS map may vary depending on EMS or HCU type.

Referring to FIGS. 7A and 7B, the virtual APS map described with reference to FIG. 6 can be broken down based on speed for ease of explanation.

The virtual APS Map shown in FIG. 6 may be broken down into vehicle speed (vhcl_spd), required torque (SCC_tq), and APS, as shown in FIG. 7A.

For example, for index 0, the vehicle speed (vhcl_spd) may be 20, the required torque (SCC_tq) may be 10, and the APS may be 7.460938. For index 1, the vehicle speed (vhcl_spd) may be 25, the required torque (SCC_tq) may be 10, and the APS may be 7.460938. For index 2, the vehicle speed (vhcl_spd) may be 30, the required torque (SCC_tq) may be 10, and the APS may be 7.460938. For index 3, the vehicle speed (vhcl_spd) may be 35, the required torque (SCC_tq) may be 10, and the APS may be 7.460938. For index 4, the vehicle speed (vhcl_spd) may be 40, the required torque (SCC_tq) may be 10, and the APS may be 7.460938.

The processor may use such a subdivided virtual APS map to predict RPM for each index, as shown in FIG. 7B. In FIG. 7B, results of predicting RPM at a first gear stage on a flat surface are shown, but examples are not limited thereto.

For example, for index 0, the vehicle speed (vhcl_spd) may be 20, the required torque (SCC_tq) may be 10, the APS may be 7.460938, and the RPM_gear 1 may be 460.9531. For index 1, the vehicle speed (vhcl_spd) may be 25, the required torque (SCC_tq) may be 10, the APS may be 7.460938, and the RPM_gear 1 may be 566.7951. For index 2, the vehicle speed (vhcl_spd) may be 30, the required torque (SCC_tq) may be 10, the APS may be 7.460938, and the RPM_gear 1 may be 672.6371. For index 3, the vehicle speed (vhcl_spd) may be 35, the required torque (SCC_tq) may be 10, the APS may be 7.460938, and the RPM gear 1 may be 778.4791. For index 4, the vehicle speed (vhcl_spd) may be 40, the required torque (SCC_tq) may be 10, the APS may be 7.460938, and the RPM_gear 1 may be 884.3211.

As described above, the processor may subdivide the virtual APS map such that the results shown in FIGS. 7A and 7B are broken down by road gradient by gear stage, and may use this subdivided virtual APS map to more accurately predict RPM.

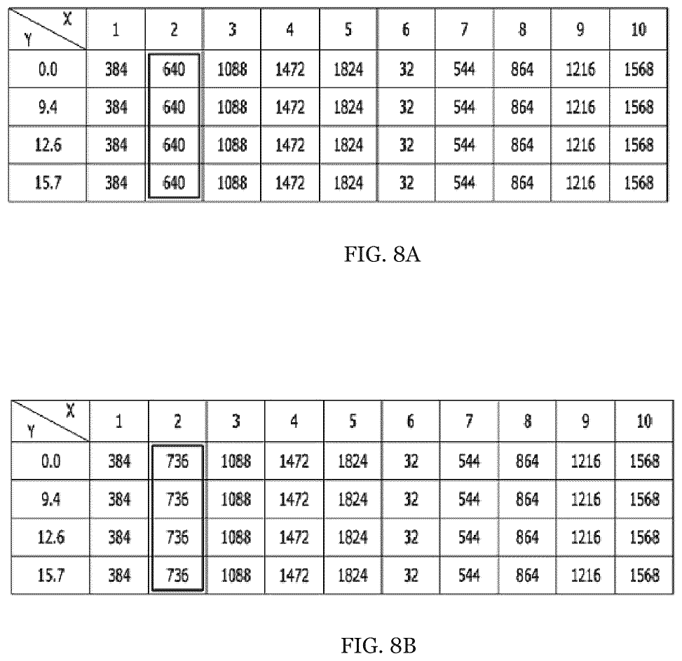

FIGS. 8A and 8B are diagrams illustrating a shift pattern map according to an embodiment of the present disclosure.

As shown in FIGS. 8A and 8B, the shift pattern map is as follows. FIG. 8A shows a shift pattern map based on a flat road, and FIG. 8B shows a shift pattern map based on a road with road gradient.

In FIGS. 8A and 8B, the horizontal direction, i.e., the x-axis, of the shift pattern map represents a gear stage (up/down), and the vertical direction, i.e., the y-axis, represents an APS.

In FIGS. 8A and 8B, the shift pattern map shows that, as the gear stage increases, the APS also increases. For example, a higher gear stage may provide more speed but relatively less power. As the road gradient increases, the power required to maintain the speed may be relatively greater.

That is, the autonomous vehicle may be required to drive further at a lower gear stage as the road gradient increases.

For example, the RPM to shift into a second gear stage (refer to the bold boxes) with the same APS may be higher in the shift pattern map with a high road gradient shown in FIG. 8B than in the shift pattern map on the flat road shown in FIG. 8A.

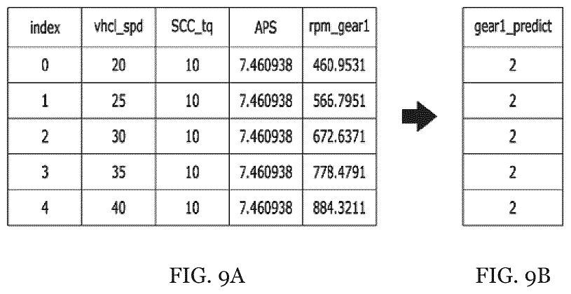

FIGS. 9A and 9B are diagrams illustrating a result of predicting a gear stage according to an embodiment of the present disclosure.

Referring to FIGS. 9A and 9B, the processor may predict a gear stage or a gear step, using a subdivided virtual APS map and a shift pattern map. FIGS. 9A and 9B illustrate the results of predicting a gear stage for each virtual APS index on a flat road based on a first gear stage.

The table shown in FIG. 9A illustrates the subdivided virtual APS map, for which a more detailed or repeated description will be omitted here as it has been fully described above.

As shown in FIG. 9B, the processor may compare the predicted RRM and the virtual APS at each gear stage to the road gradient-specific shift pattern map. Based on results of the comparison and analysis, the processor may predict or select a corresponding gear stage per virtual APS index.

For example, for index 0, RPM_gear 1 may be 460.9531, and the predicted gear stage corresponding to the virtual APS index may be 2. For index 1, RPM_gear 1 may be 566.7951, and the predicted gear stage corresponding to the virtual APS index may be 2. For index 2, RPM_gear 1 may be 672.6371, and the predicted gear stage corresponding to the virtual APS index may be 2. For index 3, RPM_gear 1 may be 778.4791, and the predicted gear stage corresponding to the virtual APS index may be 2. For index 4, RPM_gear 1 may be 884.3211, and the predicted gear stage corresponding to the virtual APS index may be 2.

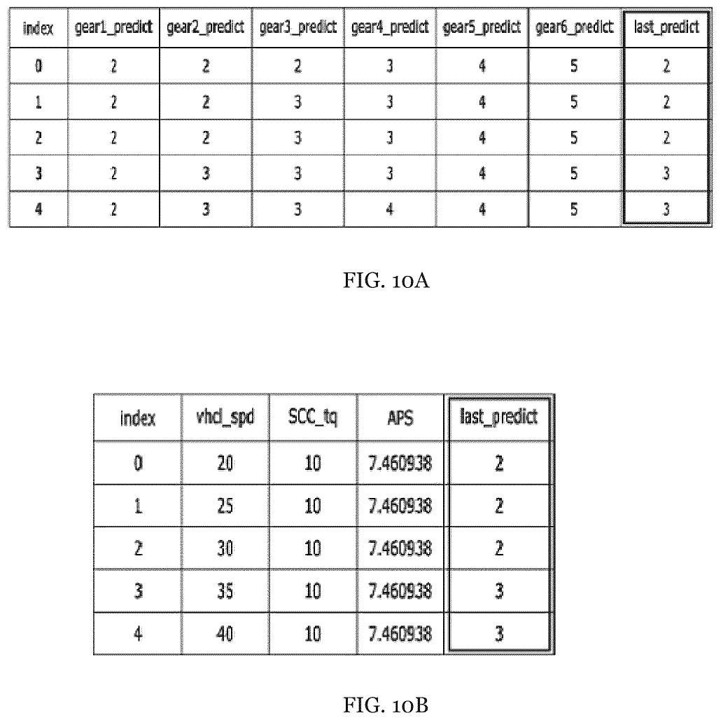

FIGS. 10A and 10B are diagrams illustrating an example of determining a final gear stage for each index in a subdivided virtual APS map according to an embodiment of the present disclosure.

Referring to FIG. 10A, the processor may compare and analyze a gear stage determined through each gear stage, and determine a final gear stage for each index in a subdivided virtual APS map based on results of the comparison and analysis.

For example, the processor may analyze and compare a gear stage determined from each gear, starting from gear 1, to a current gear stage, and determine that there is no change when a result value obtained by the analysis is within a reference gear range. The processor may then determine a final gear stage in the corresponding row to be the current gear stage.

In contrast, the processor may determine that there is a change in the gear stage when the result value from the analysis is out of the reference gear stage. Accordingly, the processor may select a gear stage that is one stage higher from the determined current gear stage, and recheck a corresponding result from the selected gear stage to determine the gear stage.

For example, for index o, when gear 1_predict is 2, gear 2_predict is 2, gear 3_predict is 2, gear 4_predict is 3, gear 5_predict is 4, and gear 6_predict is 5, the final gear stage (last_predict) may be 2. For index 1, when gear 1_predict is 2, gear 2_predict is 2, gear 3_ predict is 3, gear 4_predict is 3, gear 5_predict is 4, and gear 6_predict is 5, the final gear stage (last_predict) may be 2. For index 2, when gear 1_predict is 2, gear 2_predict is 2, gear 3_predict is 3, gear 4_predict is 3, gear 5_predict is 4, and gear 6_predict is 5, the final gear stage (last_predict) may be 2. For index 3, when gear 1_predict is 2, gear 2_predict is 3, gear 3_predict is 3, gear 4_predict is 4, gear 5_predict is 4, and gear 6_predict is 5, the final gear stage (last_predict) may be 3.

For example, as shown in FIG. 10A, a gear stage predicted at index 0 from gear 1 is a second gear stage. Also, a result from gear 2 is still the second gear stage, and thus the final gear stage at index 0 may be determined to be the second gear stage.

In contrast, as shown in FIG. 10A, a gear stage predicted at index 3 from gear 1 is a second gear stage. A result from gear 2 is a third gear stage and a result from gear 3 is still the third gear stage, and thus the final gear stage may be determined to be the third gear stage.

The processor may then determine the finally determined gear stage as a final gear stage for the virtual APS map subdivided by index, as shown in FIG. 10B. The processor may determine it for each road gradient. However, examples are not limited thereto.

For example, for index 0, the vehicle speed (vhcl_spd) may be 20, the required torque (SCC_tq) may be 10, the APS may be 7.460938, and the final gear stage (last gear) may be second gear stage (gear 2). For index 1, the vehicle speed (vhcl_spd) may be 25, the required torque (SCC_tq) may be 10, the APS may be 7.460938, and the final gear stage (last gear) may be second gear stage (gear 2). For index 2, the vehicle speed (vhcl_spd) may be 30, the required torque (SCC_tq) may be 10, the APS may be 7.460938, and the final gear stage (last gear) may be second gear stage (gear 2). For index 3, the vehicle speed (vhcl_spd) may be 35, the required torque (SCC_tq) may be 10, the APS may be 7.460938, and the final gear stage (last gear) may be third gear stage (gear 3). For index 4, the vehicle speed (vhcl_spd) may be 40, the required torque (SCC_tq) may be 10, the APS may be 7.460938, and the final gear stage (last gear) may be third gear stage (gear 3).

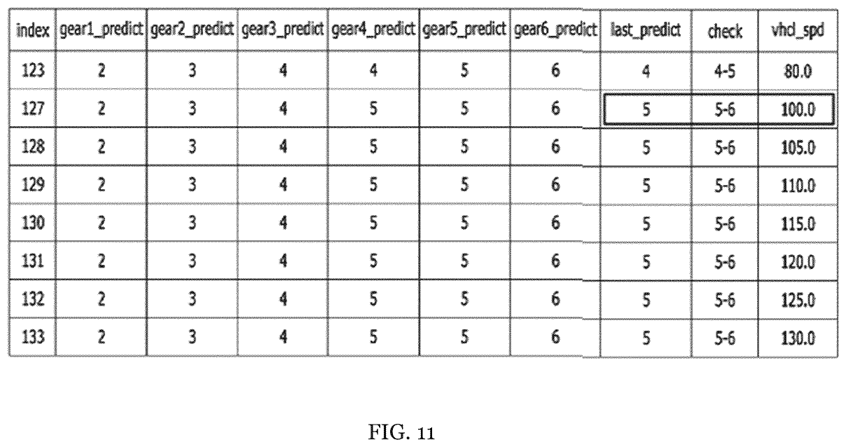

FIG. 11 is a diagram illustrating an example of determining the suitability of a final gear stage for each index in a subdivided virtual APS map according to an embodiment of the present disclosure.

Referring to FIG. 11, the autonomous vehicle may determine whether a final gear stage for each index is suitable based on a determined virtual APS map, and determine whether to change a shift pattern map based on a result value obtained by the determination, under control of the processor.

For example, the processor may set in advance a reference gear range for gear stages. The reference gear range of the gear stages may be defined as speeds corresponding to RPMs that do not cause noise to the driver while driving the vehicle at each gear stage. The reference gear range may be set based on one or more data. However, examples are not limited thereto, and this reference range of the gear stages may be set separately for different road gradients.

In response to a speed being out of the preset reference gear range, the processor may determine that there is an anomaly. That is, in response to the speed being out of the preset reference gear range, the processor may determine that there is a problem with an index at which the speed is out of the reference range.

For example, as shown in FIG. 11, the processor may determine that there is a problem if the speed of 100 kph continues at a fifth gear stage (gear 5). For example, because the processor predicts the fifth gear stage for index 127, but the speed corresponding to index 127 is still 100 kph (refer to the bold box), the processor may determine that there is a problem at index 127.

As described above, when determining a problem at an index due to the deviation from the preset reference gear range, the processor may lower RPM set in the shift pattern map for the index from which the problem is determined, thereby controlling a gear stage to be upshifted (up).

That is, lowering the RPM corresponding to an APS lower than a problematic APS in the shift pattern map under the control of the processor may improve such a problematic part naturally.

According to the example embodiments of the present disclosure described above, the autonomous vehicle may identify a minimum index that is problematic for each predicted gear stage in the virtual APS map, under control of the processor.

The autonomous vehicle may then select an APS corresponding to the minimum problematic index identified in the virtual APS map, under control of the processor.

The autonomous vehicle may then set an index corresponding to the greatest value among the APS or less identified from the gear stage requiring an improvement in the shift pattern map, under control of the processor. The processor may preferentially set a start point for which the improvement is required. The start point requiring the improvement may be an index corresponding to the greatest value among the APS or less.

The autonomous vehicle may then select, from the virtual APS map, a predicted RPM corresponding to the minimum index that is problematic, under control of the processor.

The autonomous vehicle may then divide the RPM of the index identified in the shift pattern map by the selected predicted RPM, under control of the processor. For example, the autonomous vehicle may divide the predicted RPM at the minimum problematic index of the virtual APS map by the RPM at the index of the improvement start point in the shift pattern map to calculate a first tuning value, under control of the processor.

The autonomous vehicle may divide the RPM of the index that is one lower than the RPM of the index based on the set shift pattern map by the RPM of the index to calculate a second tuning value, under control of the processor.

When the first tuning value is less than the second tuning value, the RPM values above and below the index may be reversed, and thus the autonomous vehicle may set the second tuning value as a tuning factor, under control of the processor. In contrast, when the first tuning value is greater than or equal to the second tuning value, the autonomous vehicle may set the first tuning value as the tuning factor, under control of the processor.

Subsequently, the autonomous vehicle may perform tuning on the shift pattern map by sequentially multiplying the indices, starting from an index corresponding to the greatest value of the APS or less values identified at the gear stage that needs an improvement to the last index, based on the set tuning factor, under control of the processor.

The autonomous vehicle may then determine a final tuning pattern after checking for a frequent shifting problem and an up/down pattern reversal problem, under control of the processor.

The autonomous vehicle may also perform the tuning described above separately for each road gradient, under control of the processor, because the shift pattern map differs for each road gradient, if any.

The autonomous vehicle may also predict a gear stage for each index in the virtual APS map using the tuned shift pattern map, and apply the predicted gear stage to redetermine a final gear stage for each index, under control of the processor.

For example, after predicting the gear stage for each index of the virtual APS map using the tuned shift pattern map, the autonomous vehicle may change the gear stage for each index, under control of the processor. When the gear stage upshifted (up) due to the changed upshift pattern is predicted to be a gear stage one stage lower than the final gear stage predicated by that gear stage, the autonomous vehicle may determine that a frequent shifting problem is highly likely to occur at the corresponding index, under control of the processor.

For example, the autonomous vehicle may perform upshift pattern tuning on gear 3-4 to change the gear stage to gear 4 based on a predicted RPM relative to gear 3 at a specific index, under control of the processor. The autonomous vehicle may determine that there is a problem if the RPM prediction based on the changed gear 4 is changed to gear 3 at the index, under control of the processor.

As described above, when it is determined that a frequent shifting problem is highly likely to occur at the index, the autonomous vehicle may identify a predicted RPM corresponding to the problematic index in the virtual APS map, under control of the process.

The autonomous vehicle may then analyze an index corresponding to a greatest RPM among the identified RPM value or less on the shift pattern map that is one before the tuning, under control of the processor.

When the analyzed index is less than or equal to the previous index, the autonomous vehicle may then maintain the previous shift pattern map, under control of the processor. However, examples are not limited thereto.

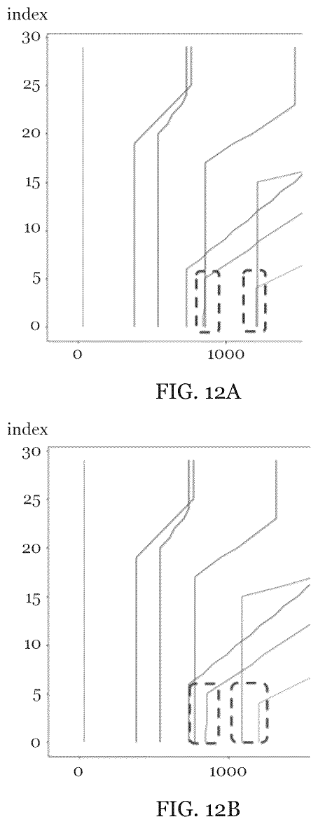

FIGS. 12A and 12B are diagrams illustrating an example of determining whether there is a down pattern and a reversal phenomenon based on a shift pattern tuning result according to an embodiment of the present disclosure.

In FIGS. 12A and 12B, FIG. 12A shows a state before correction, and FIG. 12B shows a state after the correction.

Referring to FIGS. 12A and 12B, the autonomous vehicle may compare and analyze, for the tuned shift pattern map, RPMs corresponding to the up pattern and the down pattern for each gear stage by index, under control of the processor. When, based on resulting values obtained by the comparison and analysis, an index at which RPM of the up pattern is less than RPM of the down pattern is identified, the autonomous vehicle may determine that there is a problem, under control of the processor.

The autonomous vehicle may extract a greatest index value among indices on the shift pattern map from which the problem is identified based on a result of the determining, under control of the processor.

The autonomous vehicle may then apply, up to the first index, RPM at an index one greater than the index extracted from the tuned shift pattern map to perform correction to prevent the down pattern and reversal from occurring, under control of the processor.

The example embodiments of the present disclosure described herein may be implemented as computer-readable code on a storage medium in which a program is recorded. The computer-readable medium may include all types of recording devices that store data to be read by a computer system. The computer-readable medium may include, for example, a hard disk drive (HDD), a solid-state drive (SSD), a silicon disk drive (SDD), a read-only memory (ROM), a random-access memory (RAM), a compact disc ROM (CD-ROM), a magnetic tape, a floppy disk, an optical data storage device, the like, or any combination thereof.

Accordingly, the preceding detailed description should not be construed as necessarily restrictive but as illustrative. The scopes of embodiments of the present disclosure can be determined by reasonable interpretation of the appended claims, and all changes and modifications within the equivalent scopes of the present disclosure can be included in the scopes of the present disclosure.

What is claimed is:

1. A method of controlling an ego vehicle comprising at least one processor, the method comprising:
obtaining, by control of the at least one processor, first driving state information of a front vehicle traveling before the ego vehicle via at least one sensor of the ego vehicle;
determining, by control of the at least one processor, a required torque for the ego vehicle based on the first driving state information of the front vehicle and second driving state information of the ego vehicle;
generating, by control of the at least one processor, a virtual accelerator pedal sensor (APS) map for the ego vehicle based on the required torque and the second driving state information of the ego vehicle;
determining, by control of the at least one processor, revolutions per minute (RPM) and a gear stage of the ego vehicle based on the virtual APS map;
determining, by control of the at least one processor, a final gear stage of the ego vehicle based on the determined gear stage and a preset gear stage; and
in response to the determined final gear stage being out of a preset reference gear range, redetermining, by control of the at least one processor, the final gear stage based on a shift pattern map.

2. The method of claim 1, wherein the second driving state information of the ego vehicle comprises a vehicle speed, a virtual APS, a vehicle longitudinal acceleration, a road gradient, a required acceleration, and the RPM; and
wherein the method further comprises predicting, by control of the at least one processor, a correlation between the vehicle speed, the virtual APS, the vehicle longitudinal acceleration, the road gradient, the required acceleration, and the RPM.

3. The method of claim 1, further comprising:
extracting, by control of the at least one processor, feature values from a vehicle speed and a virtual APS; and
generating a neural network model configured to predict the RPM based on the feature values.

4. The method of claim 3, further comprising training the neural network model with learning data until a determination coefficient reaches a preset reference value, wherein the determination coefficient is a result value of a correlation coefficient.

5. The method of claim 1, further comprising:
subdividing, by control of the at least one processor, the virtual APS map; and
predicting an RPM per index based on the subdivided virtual APS map.

6. The method of claim 5, further comprising:
determining, by control of the at least one processor, whether a final gear stage per index is suitable or not based on the virtual APS map; and
determining, by control of the at least one processor, whether to change the shift pattern map based on a result of the determining whether the final gear stage per index is suitable or not.

7. The method of claim 1, further comprising, in response to the determined final gear stage being within the preset reference gear range, determining, by control of the at least one processor, the final gear stage as a current gear stage.

8. The method of claim 1, further comprising, in response to the determined final gear stage being out of the preset reference gear range, lowering, by control of the at least one processor, the RPM set in the shift pattern map.

9. An ego vehicle comprising:
at least one processor; and
a storage medium storing computer-readable instructions that, when executed by the at least one processor, enable the at least one processor to:
obtain, via at least one sensor, first driving state information of a front vehicle traveling before the ego vehicle;
determine a required torque of the ego vehicle based on the first driving state information of the front vehicle and second driving state information of the ego vehicle;
generate a virtual accelerator pedal sensor (APS) map for the ego vehicle based on the required torque and the second driving state information of the ego vehicle;
determine revolutions per minute (RPM) and a gear stage of the ego vehicle based on the virtual APS map;
determine a final gear stage of the ego vehicle based on a predicted gear stage and a preset gear stage; and
in response to the determined final gear stage being out of a preset reference gear range, redetermine the final gear stage based on a shift pattern map.

10. The ego vehicle of claim 9, wherein the second driving state information of the ego vehicle comprises a vehicle speed, a virtual APS, a vehicle longitudinal acceleration, a road gradient, a required acceleration, and an RPM; and
wherein the instructions further enable the at least one processor to predict a correlation between the vehicle speed, the virtual APS, the vehicle longitudinal acceleration, the road gradient, the required acceleration, and the RPM.

11. The ego vehicle of claim 9, wherein the instructions further enable the at least one processor to:
extract feature values of the ego vehicle from a vehicle speed and a virtual APS of the ego vehicle; and
generate a neural network model configured to predict the RPM of the ego vehicle based on the feature values of the ego vehicle.

12. The ego vehicle of claim 11, wherein the instructions further enable the at least one processor to train the neural network model with learning data until a determination coefficient reaches a preset reference value, wherein the determination coefficient is a result value of a correlation coefficient.

13. The ego vehicle of claim 9, wherein the instructions further enable the at least one processor to:
subdivide the virtual APS map; and
predict an RPM per index based on the subdivided virtual APS map.

14. The ego vehicle of claim 13, wherein the instructions further enable the at least one processor to:
determine whether a final gear stage per index is suitable or not based on the virtual APS map; and
determine whether to change the shift pattern map based on a result of the determining whether the final gear stage per index is suitable or not.

15. The ego vehicle of claim 9, wherein the instructions further enable the at least one processor to, in response to the determined final gear stage being within the preset reference gear range, determine the final gear stage as a current gear stage.

16. The ego vehicle of claim 9, wherein the instructions further enable the at least one processor to, in response to the determined final gear stage being out of the preset reference gear range, lower the RPM set in the shift pattern map.

17. A method of controlling an ego vehicle, the method comprising:
obtaining first driving state information of a front vehicle traveling before the ego vehicle;
determining a required torque for the ego vehicle based on the first driving state information of the front vehicle and second driving state information of the ego vehicle;
generating a virtual accelerator pedal sensor (APS) map for the ego vehicle based on the required torque and the second driving state information of the ego vehicle;
determining revolutions per minute (RPM) and a gear stage of the ego vehicle based on the virtual APS map;
determining a final gear stage of the ego vehicle based on the determined gear stage and a preset gear stage;
if the determined final gear stage is out of a preset reference gear range, redetermining the final gear stage based on a shift pattern map, and lowering the RPM set in the shift pattern map; and
if the determined final gear stage is within the preset reference gear range, determining the final gear stage as a current gear stage.

18. The method of claim 17, wherein the second driving state information of the ego vehicle comprises a vehicle speed, a virtual APS, a vehicle longitudinal acceleration, a road gradient, a required acceleration, and the RPM; and
wherein the method further comprises predicting a correlation between the vehicle speed, the virtual APS, the vehicle longitudinal acceleration, the road gradient, the required acceleration, and the RPM.

19. The method of claim 17, further comprising:
extracting feature values from a vehicle speed and a virtual APS;
generating a neural network model configured to predict the RPM based on the feature values; and
training the neural network model with learning data until a determination coefficient reaches a preset reference value, wherein the determination coefficient is a result value of a correlation coefficient.

20. The method of claim 17, further comprising:
subdividing the virtual APS map;
predicting an RPM per index based on the subdivided virtual APS map;
determining whether a final gear stage per index is suitable or not based on the virtual APS map; and
determining whether to change the shift pattern map based on a result of the determining whether the final gear stage per index is suitable or not.
